(19) United States
(12) Patent Application Publication
(10) Pub. No.: US 2007/0192424 A1
(43) Pub. Date: Aug. 16, 2007

(54) INFORMATION PROCESSING APPARATUS AND METHOD THEREOF

(76) Inventor: Junichi Minato, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/671,812

(22) Filed: Feb. 6, 2007

(30) Foreign Application Priority Data
Feb. 8, 2006 (JP) 2006-031259

(51) Int. Cl. G06F 15/16

(52) U.S. Cl. 709/206

(57) ABSTRACT

An information processing apparatus is disclosed. The information processing apparatus includes a received mail information obtaining unit for obtaining received mail information including a mail account and a mail server address from an image code, a reply destination address obtaining unit for obtaining a reply destination address from the received mail, a transmitter address obtaining unit for making the mail account a transmitter address, a reply mail information code generating unit for generating a reply mail information code in which reply mail information including the reply destination address and so on is converted into an image code, an invoice image generating unit for generating an invoice image including the reply destination address or the transmitter address, and a reply mail text message description image forming unit for forming a reply mail text message description image including the reply mail information code, the invoice image, and a reply mail text message writing field.

### BACKGROUND OF THE INVENTION

1. Field of the Invention

The present invention generally relates to an information processing apparatus and a method thereof.

2. Description of the Related Art

Conventionally, there is an apparatus and a method in which an image including a letter and a sign formed or attached on a recording medium such as paper is read by a scanner and the image is processed. In the apparatus and the method, a user can perform a process on the image without using a keyboard and so on by recording an object to be processed and the contents of the process on a recording medium.

In Patent Document 1, a document managing method is disclosed. In the method, a user selects a check box formed on a cover sheet by handwriting and so on, the cover sheet is read by a scanner, and an apparatus such as a MFP (multifunctional peripheral) processes a document.

On the cover sheet, a check box corresponding to, for example, a thumbnail image of a document or the contents of a process is written. The user selects a document to be processed and the contents of the process by marking a check box.

An apparatus for executing the method is, for example, a MFP, and the check box marked by the user is detected by comparing the marked check box with a check box stored in the MFP. The document or the contents of the process corresponding to the marked check box are obtained by the MFP. For example, the MFP refers to a map in which the coordinates of the check box correspond to the document or the contents of the process of the marked check box. The MFP applies a selected process to a selected document. When the contents or the structure of the document is changed, the MFP forms a cover sheet corresponding to the contents and the structure of the changed document.

In addition, in Patent Document 1, a method for transmitting an e-mail or a facsimile is disclosed. When an e-mail or a facsimile is transmitted, a cover sheet is read by a scanner on which cover sheet a check box for the process and a check box for a document to be processed are marked.

Routing information showing a destination of the e-mail or the facsimile is written by a user at a predetermined field on the cover sheet. Or the user designates the routing information on the cover sheet via a control interface. Then, the routing information is determined by referring to the cover sheet, by applying an OCR (optical character reader) process to the cover sheet, or by a process of the control interface.

In addition, another method is disclosed. In the method, the MFP reads a cover sheet on which an operation sticker is attached. With this, a document to be processed and the contents of a process to be applied to the document are selected.

[Patent Document 1] Japanese Laid-Open Patent Application No. 2005-295564

However, in Patent Document 1, the process is applied to a selected document, and a method is not disclosed in which method a process is selected based on the contents of the selected document.

For example, when the selected document is an e-mail, the text message of the e-mail may be edited or revised, or a reply message for the received message may be transmitted. When the reply message is transmitted, the routing information such as a mail address of the received message and a mail server address must be obtained. Further, a text message of the reply mail must be written, and the text message of the reply mail is transmitted to the mail address of the destination.

In Patent Document 1, when a reply message is transmitted by using a cover sheet, a cover sheet is needed in which sheet fields for writing routing information of the destination and for writing a reply message are required. The routing information can be obtained from the received e-mail. However, the cover sheet having the above fields is not described.

### SUMMARY OF THE INVENTION

In a preferred embodiment of the present invention, there is provided an information processing apparatus and a method thereof in which performing a process and forming a text message are easily executed without a complex input by using a device when a reply message is transmitted.

Features and advantages of the present invention are set forth in the description that follows, and in part will become apparent from the description and the accompanying drawings, or may be learned by practice of the invention according to the teachings provided in the description. Features and advantages of the present invention will be realized and attained by an information processing apparatus and a method thereof particularly pointed out in the specification in such full, clear, concise, and exact terms as to enable a person having ordinary skill in the art to practice the invention.

To achieve one or more of these and other advantages, according to one aspect of the present invention, there is provided an information processing apparatus which forms an image including a reply mail text message writing field to which a reply mail text message is written for transmitting a reply mail in response to a received mail based on received mail information written as an image code. The information processing apparatus includes a received mail information obtaining unit for obtaining the received mail information including a mail account and a mail server address from the image code, a reply destination address obtaining unit for obtaining a reply destination address for the received mail from the received mail information, a transmitter address obtaining unit for obtaining a transmitter address of the received mail which address is a mail address of the mail account, a reply mail information code generating unit for generating a reply mail information code in which reply mail information including the reply destination address, the transmitter address, and the mail server address is converted into an image code, an invoice image generating unit for generating an invoice image including the reply destination address or the transmitter address, and a reply mail text message description image forming unit for forming a reply mail text message description image including the reply mail information code, the invoice image, and the reply mail text message writing field.

According to another aspect of the present invention, there is provided an information processing method which forms an image including a reply mail text message writing field to which a reply mail text message is written for transmitting a reply mail in response to a received mail based on received mail information written as an image code. The information processing method includes the steps of obtaining the received mail information including a mail account and a mail server address from the image code; obtaining a reply destination address for the received mail from the received mail information; obtaining a transmitter address of the received mail which address is a mail address of the mail account; generating a reply mail information code in which reply mail information including the reply destination address, the transmitter address; and the mail server address is converted into an image code; generating an invoice image including the reply destination address or the transmitter address; and forming a reply mail text message description image including the reply mail information code, the invoice image, and the reply mail text message writing field.

### EFFECT OF THE INVENTION

According to an embodiment of the present invention, an information processing apparatus and an information processing method can be obtained in which performing a process and forming a text message are easily executed without a complex input by using a device when a reply message is transmitted.

### BRIEF DESCRIPTION OF THE DRAWINGS

Features and advantages of the present invention will become more apparent from the following detailed description when read in conjunction with the accompanying drawings, in which:

FIG. 1 is a block diagram showing an information processing apparatus according to an embodiment of the present invention;

FIG. 2 is a diagram showing a hardware structure of the information processing apparatus according to the embodiment of the present invention;

FIG. 3 is a functional diagram of the information processing apparatus according to the embodiment of the present invention;

FIG. 4 a process chart showing processes from receiving a mail to forming a reply mail text message description image and to forming a reply destination address selection image according to the embodiment of the present invention;

FIG. 5A is a diagram showing processes for generating a mail receiver sheet for receiving a mail;

FIG. 5B is a process chart showing processes for transmitting a reply mail;

FIG. 6 is a sequence chart showing processes from scanning the mail receiver sheet to receiving a mail;

FIG. 7 is a diagram showing a screen on which identification information is requested to be input;

FIG. 8 is a sequence chart showing processes for selecting a reply mail from one or more received mails;

FIG. 9 is another sequence chart showing processes for selecting a reply mail from one or more received mails;

FIG. 10A is a diagram showing a received mail list on an operating panel;

FIG. 10B is another diagram showing a received mail list on the operating panel;

FIG. 11A is a diagram showing one of the selected received mails shown in FIG. 10B;

FIG. 11B is a diagram showing destination addresses and names of the selected received mail shown in FIG. 11A;

FIG. 11C is a diagram showing destination addresses of a reply mail for the selected received mail shown in FIG. 11A;

FIG. 12 is a sequence chart showing processes for outputting a reply mail text message description image based on reply mail information;

FIG. 13A is a diagram showing a reply mail text message description image;

FIG. 13B is a diagram showing a reply mail text message description image in which a text message of a received mail is referred to;

FIG. 14 is a sequence chart showing processes for obtaining a reply destination address candidate;

FIG. 15 is a sequence chart showing processes for forming a reply destination address selection image;

FIG. 16A is a diagram showing a reply destination address selection image;

FIG. 16B is a diagram showing a reply mail text message description image corresponding to the reply destination address selection image shown in FIG. 16A;

FIG. 17 is a sequence chart showing processes for obtaining reply mail information from a reply mail information code;

FIG. 18 is a sequence chart showing processes for transmitting a reply mail based on reply mail information;

FIG. 19 is a sequence chart showing processes for transmitting a reply mail based on a reply mail address selection image; and

FIG. 20 is a diagram showing a reply destination address selection image in which check boxes of the corresponding attributes are marked.

### DESCRIPTION OF THE PREFERRED EMBODIMENT

[Best Mode of Carrying Out the Invention]

The best mode of carrying out the present invention is described with reference to the accompanying drawings.

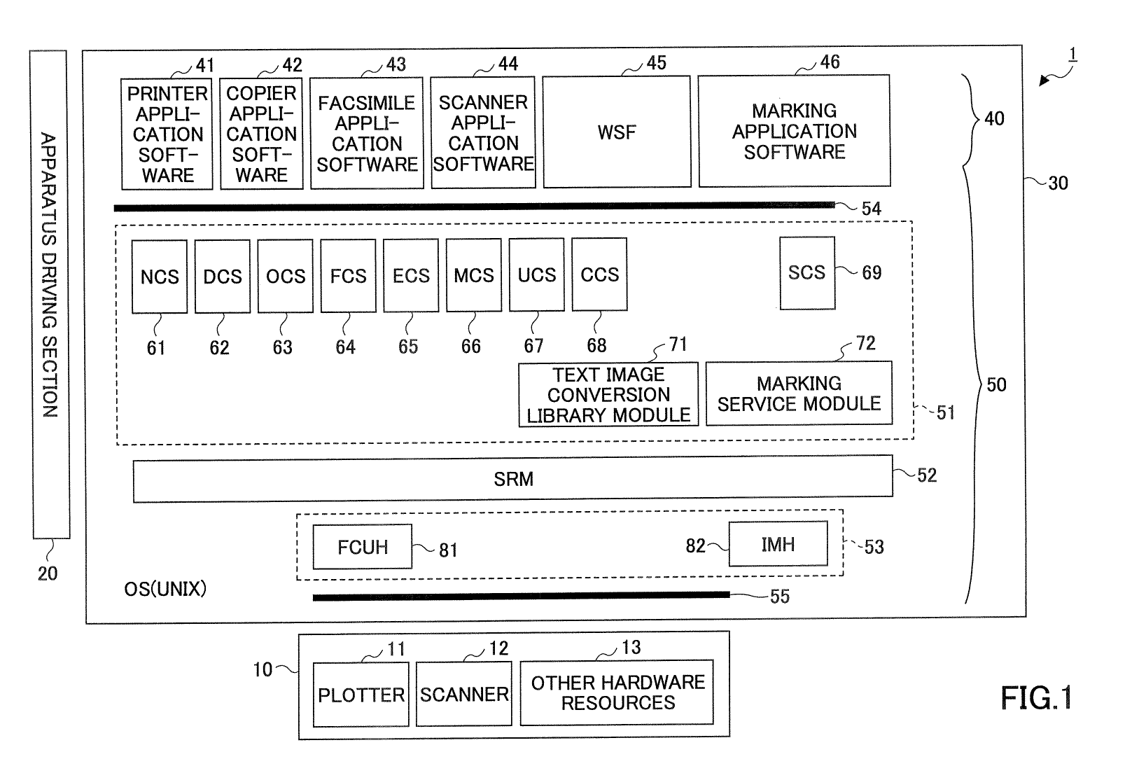

FIG. 1 is a block diagram showing an information processing apparatus according to an embodiment of the present invention.

In the embodiment of the present invention, an MFP is used as the information processing apparatus; however the apparatus is not limited to the MFP.

[Modules of MFP]

As shown in FIG. 1, an MFP 1 includes a hardware section 10, an apparatus driving section 20, and a software group 30.

The software group 30 executes processes to control the hardware section 10 and to realize functions of a printer, a copier, a facsimile, a scanner, and so on. The software group 30 includes an application layer 40 and a platform layer 50. In addition, the software group 30 includes software which is driven by an OS (operating system), for example, UNIX (trademark). Modules in the software group 30 can be formed by hardware.

The platform layer 50 manages processes common to application software by interpreting a process request from the application layer 40 and controlling the hardware section 10. The platform layer 50 includes a service module layer 51, an SRM (system resource manager) 52, a handler section 53, an API section 54, and a hardware I/F 55.

The service module layer 51 interprets a process request from the application layer 40. The service module layer 51 includes modules for generating an operation request to the hardware section 10. The modules are an NCS (network control service module) 61, a DCS (delivery control service module) 62, an OCS (operating panel control service module) 63, an FCS (facsimile control service module) 64, an ECS (engine control service module) 65, an MCS (memory control service module) 66, a UCS (user information control service module) 67, a CCS (certification and charge control service module) 68, an SCS (system control service module) 69, a text image conversion library module 71 and a marking service module 72.

The NCS 61 supplies common services to application modules which need a network I/O. That is, the NCS 61 distributes data received from external devices by each protocol via a network to application software in the application layer 40 and processes data when data from the application software are transmitted to the corresponding external devices via the network.

The NCS 61 includes, for example, a protocol stack, and controls data communications with external devices connected via a network by a ftpd (file transfer protocol daemon) in FTP (file transfer protocol) or httpd (hyper text transfer protocol daemon) in HTTP (hyper text transfer protocol).

The DCS 62 controls transmitting a stored document and an e-mail, for example, controls processes in the NCS 61. The OCS 63 controls an operating panel (not shown) which is a user interface of the MFP 1. The FCS 64 supplies APIs so that the application layer 40 controls, for example, a facsimile being transmitted or received, facsimile data stored in a backup memory being referred to, and a received facsimile being printed. The ECS 65 controls engines such as a plotter 11 and a scanner 12 in the hardware section 10. The MCS 66 controls obtaining a memory region, changing the memory region, utilizing an HDD (not shown), and managing a memory when image data are compressed or expanded.

The UCS 67 manages user information, for example, an address book and a user ID. The CCS 68 manages authentication and charging, for example, manages a unit price per piece when an image is printed and manages charging for each user. When the UCS 67 and the CCS 68 are combined, user authentication is executed.

The SCS 69 manages application modules and controls an operating section (not shown), controls displaying a system on the operating section and turning on LEDs, manages the hardware section 10, and controls an interrupted application.

The text image conversion library module 71 converts text data into an image formed of a bitmap. The marking service module 72 converts text data into an image code and obtains text data from the image code. The image code is, for example, a two-dimensional barcode such as a QR code and a one-dimensional barcode.

The SRM 52 controls a system and manages the hardware section 10 together with the SCS 69. The SRM 52 adjusts operation requests from an upper layer to operate, for example, the plotter 11 and the scanner 12 in the hardware section 10.

Specifically, the SRM 52 determines whether an engine in the hardware section 10 can be used by an operation request, that is, whether another operation request is being executed. When the engine can be used by the operation request, the SRM 52 informs the upper layer of the determined result. Further, in order to make the operation request possible, the SRM 52 makes a schedule so that the engine is used by the operation request. The other operation requests are, for example, image forming by the plotter 11, scanning a document by the scanner 12, and forming a file and obtaining a memory region by other hardware resources 13.

The handler section 53 manages the hardware section 10 based on the operation requests of the upper layer sent from the SRM 52. The handler section 53 includes a FCUH (facsimile control unit handler) 81 and an IMH (image memory handler) 82. The FCUH 81 manages an exclusive module for controlling transmission and reception of facsimiles, and the IMH 82 allocates a memory region to each process and manages the allocated memory region.

The platform layer 50 receives a process operation request from the application layer 40 via the API section 54, and the process request is input to the hardware section 10 via the hardware I/F 55.

The application layer 40 includes application software for forming an image by, for example, a printer (not shown), a copier (not shown), a facsimile (not shown), and the scanner 12, and for executing an information process with respect to a user service. That is, the application layer 40 includes printer application software 41, copier application software 42, facsimile application software 43, scanner application software 44, WSF (Web service application software) 45, and marking application software 46. That is, a Web site is searched by the WSF 45.

The marking application software 46 obtains text data to be converted into an image code and requests the marking service module 72 to convert the text data into an image code. In addition, the marking application software 46 receives text data obtained from the image code by the marking service module 72.

The hardware section 10 includes the plotter 11, the scanner 12, and other hardware resources 13 which are other engine sections of the MFP 1. The plotter 11 forms an image on a recording medium such as paper and outputs the image, and the scanner 12 obtains image information by reading an image formed on a recording medium such as paper. Further, one of the other hardware resources 13 is, for example, a facsimile.

The apparatus driving section 20 drives the application layer 40 and the platform layer 50 when a power switch (not shown) of the MFP 1 is turned on. For example, the apparatus driving section 20 reads a program for executing a process in the platform layer 50 from an HDD (not shown) and transfers the program to a memory and drives the program of the platform layer 50.

[Structure of MFP 1]

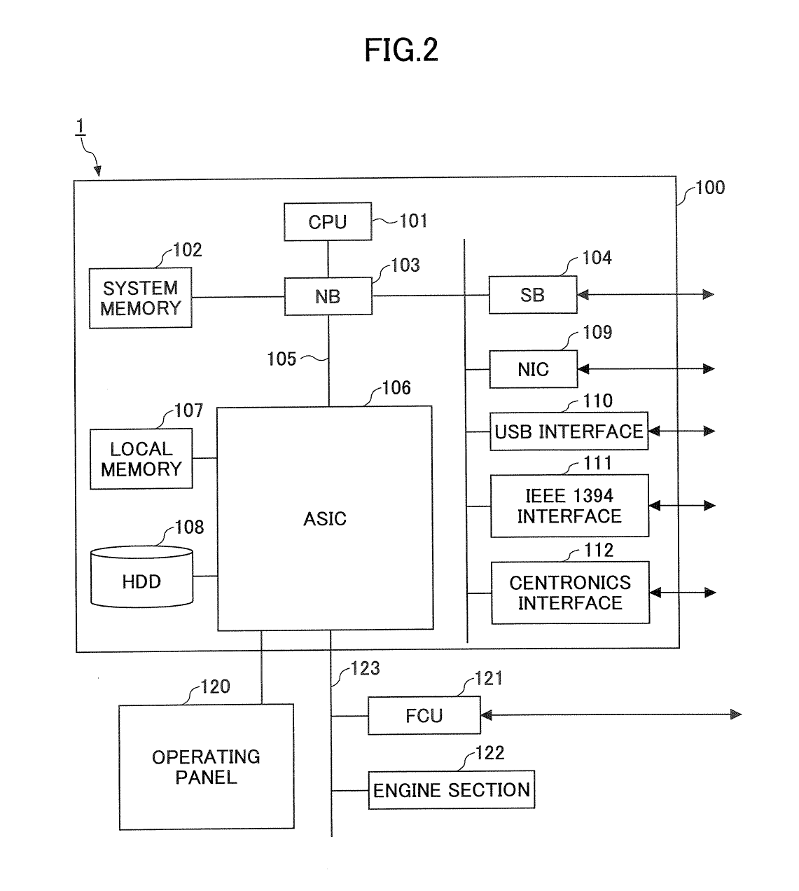

FIG. 2 is a diagram showing a hardware structure of the MFP 1 according to the embodiment of the present invention.

As shown in FIG. 2, the MFP 1 includes a controller 100, an operating panel 120, a FCU (facsimile control unit) 121, an engine section 122, and a local bus 123.

The controller 100 includes a CPU 101, a system memory 102, an NB (north bridge) 103, an SB (south bridge) 104, a local bus 105, an ASIC 106, a local memory 107, an HDD (hard disk drive) 108, an NIC (network interface) 109, a USB interface 110, an IEEE 1394 interface 111, and a Centronics interface 112.

The CPU 101 controls all the elements in the MFP 1. That is, the CPU 101 controls all the modules and application software in the software group 30. Since each module in the platform layer 50 is formed of software, the CPU 101 drives the software on the OS in the MFP 1.

The NB 103 connects the CPU 101, the system memory 102, the SB 104, and the ASIC 106. The system memory 102 stores, for example, an image for writing. The SB 104 connects the NB 103 with a ROM (not shown) and an external device (not shown) via a local bus (not shown). The local memory 107 is a buffer which stores, for example, an image for copying and a code.

The ASIC 106 is an image processing IC having a hardware module for image processing. The HDD 108 stores, for example, image data, document data, programs, font data, and forms of images. Even if an interface of the CPU 101 is unknown, when the ASIC 106 is connected to the CPU 101 via the NB 103, the CPU 101 controls the ASIC 106. The local bus 105 is, for example, an AGP (accelerated graphic port).

The NIC 109, the USB interface 110, the IEEE 1394 interface 111, and the Centronics interface 112 execute data input and output with an external device, and are connected to the NB 103 via a PCI bus or a local bus.

The NIC 109 is, for example, a LAN interface in compliance with IEEE 802.3. The Centronics interface 112 is a parallel bus interface.

On the operating panel 120, a user inputs, for example, a process request, and process contents are displayed. The operating panel 120 is connected to the ASIC 106 via a bus exclusive therebetween. The FCU 121 controls transmission and reception of facsimile data. The engine section 122 includes engines such as the plotter 11 and the scanner 12 shown in FIG. 1.

[Functions of Modules and Application Software]

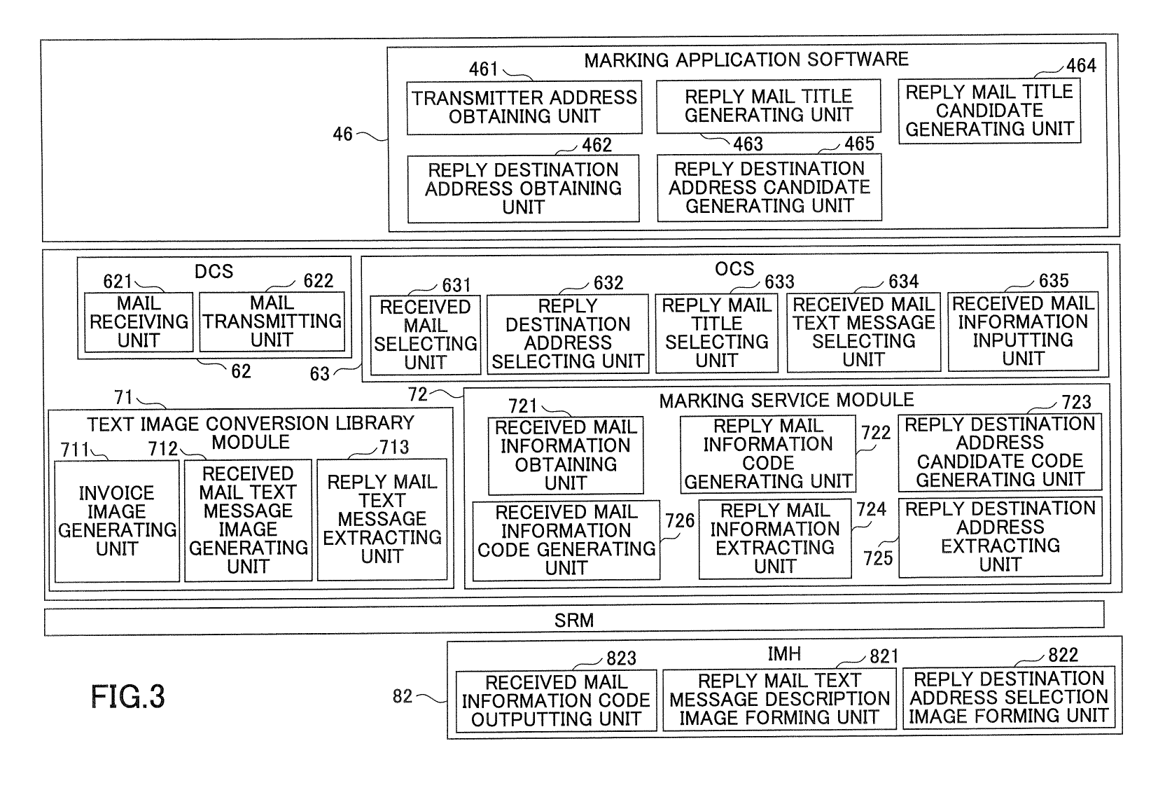

FIG. 3 is a functional diagram of the information processing apparatus according to the embodiment of the present invention. In FIG. 3, functions of a part of the modules and a part of the application software shown in FIG. 1 are described. When the information processing apparatus according to the embodiment of the present invention is realized, the functions in the modules and the application software are not limited to the functions shown in FIG. 3.

The marking application software 46 includes a transmitter address obtaining unit 461, a reply destination address obtaining unit 462, a reply mail title generating unit 463, a reply mail title candidate generating unit 464, and a reply destination address candidate generating unit 465.

The DCS 62 includes a mail receiving unit 621 and a mail transmitting unit 622. The OCS 63 includes a received mail selecting unit 631, a reply destination address selecting unit 632, a reply mail title selecting unit 633, a received mail text message selecting unit 634, and a received mail information inputting unit 635.

The text image conversion library module 71 includes an invoice image generating unit 711, a received mail text message image generating unit 712, and a reply mail text message extracting unit 713.

The marking service module 72 includes a received mail information obtaining unit 721, a reply mail information code generating unit 722, a reply destination address candidate code generating unit 723, a reply mail information extracting unit 724, a reply destination address extracting unit 725, and a received mail information code generating unit 726.

The IMH 82 includes a reply mail text message image forming unit 821, a reply destination address selection image forming unit 822, and a received mail information code outputting unit 823.

[Processes from Receiving Mail to Forming Reply Mail Text Message Description Image]

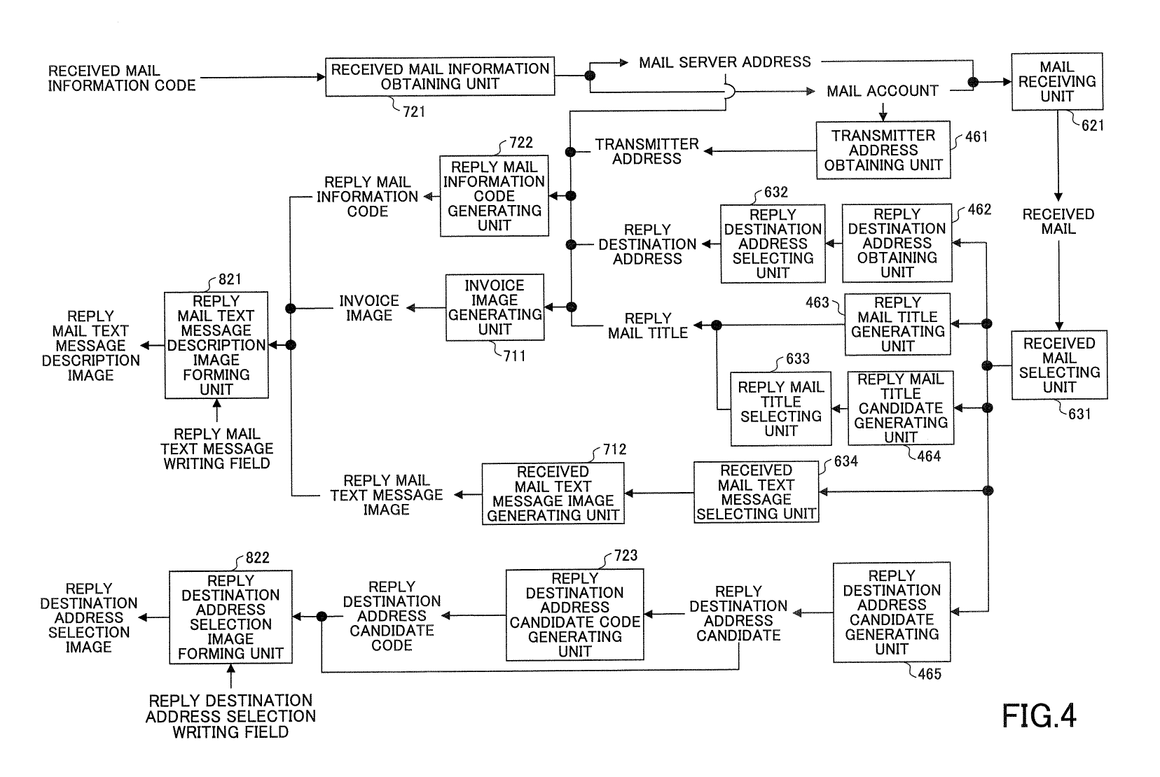

FIG. 4 a process chart showing processes from receiving a mail to forming a reply mail text message description image and to forming a reply destination address selection image.

Referring to FIG. 4, the processes are described. In the following, as described above, an image code is, for example, a two-dimensional barcode such as a QR code and a one-dimensional barcode. The image code is formed on a recording medium or displayed on a screen, and in some cases, the image code is simply referred to as a code or a marking. In addition, an image is printed on a recording medium or is displayed on a screen, or is to be printed on the recording medium or is to be displayed on the screen.

First, processes from receiving a mail to selecting the received mail to which a reply mail is to be transmitted are described.

[Processes from Receiving Mail to Selecting Received Mail to which Reply Mail is to be Transmitted]

The received mail information obtaining unit 721 obtains received mail information including a mail account and a mail server address from a received mail information code, which is read by the scanner 12 from a received mail information code image formed on a recording medium such as paper. That is, the received mail information code image is printed on the recording medium. The received mail information can include identification information such as passwords for the mail account and the mail server address. The received mail information includes the mail account and the mail server address but does not include a text message of the received mail.

The mail receiving unit 621 receives the mail including the text message based on the obtained mail account and the obtained mail server address. When plural mails are received, the received mail selecting unit 631 selects the received mail for which a reply mail is to be transmitted. The received mail selecting unit 631 selects the received mail for which the reply mail is to be transmitted based on, for example, urgency of the received mail. The received mail selecting unit 631 can be formed by the following. First, a list of the titles and the degree of urgency of the received mails are displayed on the operating panel 120, and the received mail for which a reply mail must be transmitted is selected from the list by an input by a user on the operating panel 120.

[Processes for Forming Reply Mail Text Message Description Image]

The transmitter address obtaining unit 461 obtains a transmitter address from the mail account in the received mail information.

The reply destination address obtaining unit 462 obtains a reply destination address from the transmitter address of the received mail selected by the received mail selecting unit 631. When the received mail is transmitted to plural destination addresses, the plural destination addresses can be candidates of the reply destination addresses. In addition, when two or more received mails are selected by the received mail selecting unit 631, the transmitter addresses of the selected received mails and the destination addresses of the received mail can be candidates for the reply destination addresses.

The reply destination address selecting unit 632 displays candidates for the reply destination addresses on the operating panel 120. The operating panel 120 receives a reply destination address selected by a user and returns the reply destination address to the reply destination address selecting unit 632.

The reply mail title generating unit 463 generates a reply mail title based on a predetermined rule by using the title of the received mail. In the predetermined rule, for example, “Re” is added to the title of the received mail.

When plural received mails for which a reply mail must be transmitted are selected by the received mail selecting unit 631, the reply mail title candidate generating unit 464 generates plural reply mail title candidates based on the predetermined rule. The reply mail title selecting unit 633 displays the plural reply mail title candidates on the operating panel 120. The operating panel 120 receives a candidate selected by a user and returns the reply mail title selected by the user to the reply mail title selecting unit 633.

The reply mail information code generating unit 722 generates a reply mail information code by converting reply mail information including the reply destination address(s), the mail server address, and the transmitter address into an image code. The reply mail information code generating unit 722 can generate a reply mail information code including the title of the reply mail. In addition, the reply mail information code generating unit 722 can generate a reply mail information code including identification information such as a password for the transmitter address and the mail server address.

The invoice image generating unit 711 generates an invoice image by converting the reply destination address and text data of reply mail information including the transmitter address into an image formed of a bitmap. The invoice image can include the title of the reply mail or the mail server address.

The received mail text message selecting unit 634 displays the text message of the received mail to which a reply mail is transmitted which received message is selected by the received mail selecting unit 631 on the operating panel 120, and receives a user input of selection of a part of the received text message which part is referred to the reply mail. When plural received mails are selected by the received mail selecting unit 631, the operating panel 120 receives parts of the text messages of the received mails which parts are referred to and the referring order of the referring parts form a user input, and returns the received contents to the received mail text message selecting unit 634.

The received mail text message image generating unit 712 generates a receive mail text message image by converting text data of the referring part of the received mail selected by the received mail text message selecting unit 634 into an image formed of, for example, a bitmap.

The reply mail text message description image forming unit 821 forms a reply mail text message writing field where a reply mail text message is written. Further, the reply mail text message description image forming unit 821 forms a reply mail text message description image with the invoice image, the received mail text message image, and the reply mail information code based on a predetermined format.

The reply mail text message description image formed by the reply mail text message description image forming unit 821 is output on a recording medium such as paper by the plotter 11 of the MFP 1.

In the present embodiment, in the reply mail text message description image, a part of the received mail text message image such as a referred part of the received mail or a thumbnail image of the received mail text message image is included. However, the reply mail text message image may not include the received mail text message image.

[Processes for Forming Reply Destination Address Selection Image]

When plural received mails are selected by the received mail selecting unit 631 or plural destination addresses are written in the selected received mail, the reply destination address candidate generating unit 465 obtains the transmitter addresses of the received mails or the destination addresses of the received mail as reply destination address candidates. The reply destination address candidate code generating unit 723 generates reply destination address candidate codes by converting text data of each reply destination address candidate into an image code.

The reply destination address selection image forming unit 822 forms a reply destination address selection image in which a check box corresponding to attributes such as “To”, “Cc”, and “Bcc” is set, by causing the text data of the reply destination address candidate to correspond to the reply destination address code.

The reply destination address selection image formed by the reply destination address selection image forming unit 822 is output on a recording medium such as paper by the plotter 11 of the MFP 1.

[Generation of Mail Receiver Sheet for Receiving Mail]

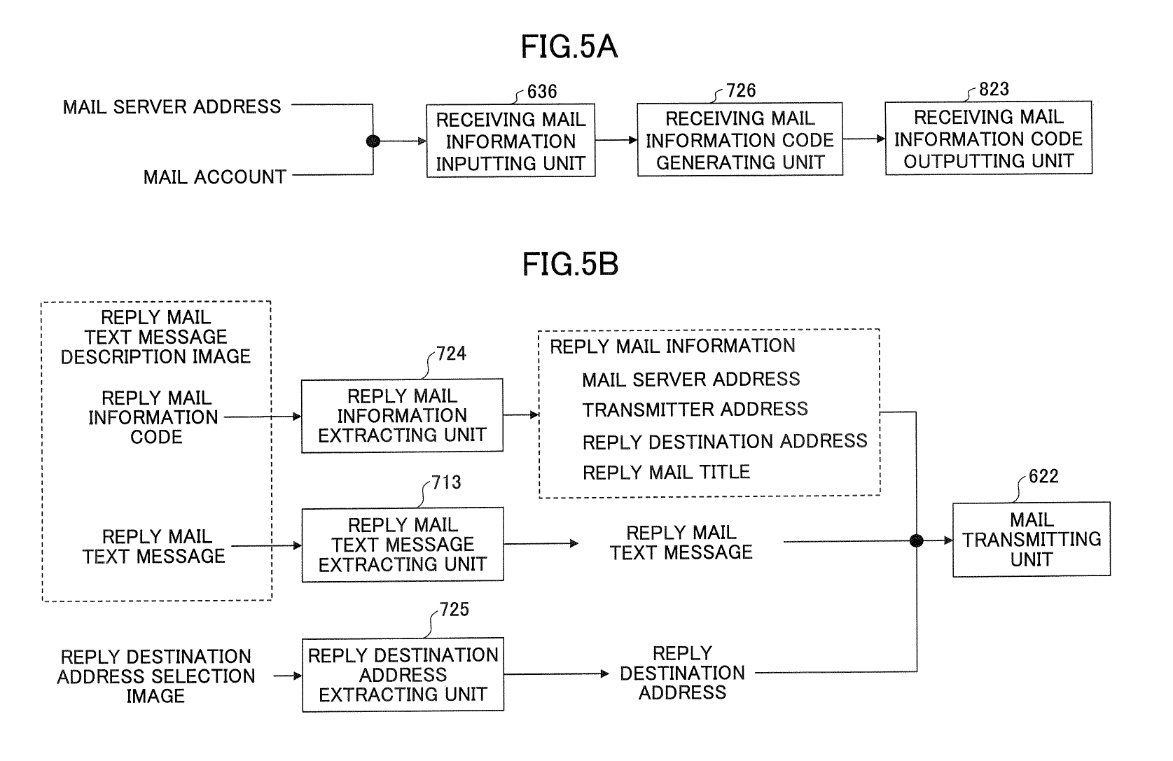

FIG. 5A is a diagram showing processes for generating a mail receiver sheet for receiving a mail. When a user carries the mail receiver sheet and the mail receiver sheet is scanned on an MFP 1 disposed even outside his/her office, the user can obtain the contents of received mails.

First, mail information including mail server addresses and mail accounts of mails to be received is input by a receiving mail information inputting unit 636. The mail information of mails to be received can be obtained from a recording medium of the MFP 1 in which medium the mail information is stored. Further, the mail information of the mails to be received can be obtained by reading a recording medium on which the mail information is stored while the scanner 12 is used and by obtaining the mail information while an OCR process is applied to the read mail information. In addition, the mail information can include identification information such as a password for the mail server address or the mail account.

A receiving mail information code generating unit 726 generates a receiving mail information code in which the mail information is converted into an image code. A receiving mail information code outputting unit 823 outputs a mail receiver sheet on which the mail information code of mails to be received is formed on a recording medium such as paper by using the plotter 11. Therefore, a user can carry the mail receiver sheet and can obtain the mail information by scanning the sheet on a MFP.

FIG. 5B is a process chart showing processes for transmitting a reply mail. The reply mail is formed of a reply mail text message image in which a text message of the reply mail is written and a reply destination address selection image in which selection a reply destination address is written.

First, the reply mail text message description image is obtained by the scanner 12 of the MFP 1. That is, it is not necessary to input a reply mail text message on a keyboard of a PC. In other words, a handwritten text message can be used as the reply mail text message being scanned by the scanner 12.

The reply mail information extracting unit 724 extracts a reply mail information code from the reply mail text message description image and obtains reply mail information from the reply mail information code. The reply mail information includes information such as the mail server address, the source address, the reply destination address, and the reply mail title. The reply mail information code can include identification information such as the password for the source address and the mail server address.

The reply mail text message extracting unit 713 extracts a text message image of the reply mail from the reply mail text message description image. The reply mail text message extracting unit 713 can extract text data from the obtained reply mail text message image while applying an OCR process.

When the reply mail information code image or the reply mail text message image is obtained from the reply mail text message description image, the coordinates of each element of which the reply mail text message description image is formed have been stored in a recording medium in the MFP 1 beforehand, the reply mail information image code or the reply mail text message image is obtained based on the coordinates.

When the reply destination address is included in the reply mail information, the mail transmitting unit 622 requests the mail server to transmit the image or the text data of the reply mail text message to the reply destination address.

When the reply destination address is determined by the reply destination address selection image, the reply destination address selection image is obtained by the scanner 12 of the MFP 1. The reply destination address extracting unit 725 extracts a marked check box and a reply destination address candidate code corresponding to the marked check box from the reply destination address selection image. Further, the reply destination address extracting unit 725 extracts text data of the reply destination address from the reply destination address candidate code as the reply destination address.

When the check box of the reply destination address selection image corresponds to one of the attributes such as “To”, “Cc”, and “Bcc”, the reply destination address extracting unit 725 extracts a reply destination address with the attribute.

The mail transmitting unit 622 transmits a reply mail to the reply destination address extracted by the reply destination address extracting unit 725. The reply mail information which is needed to transmit the reply mail is formed as the image code on the reply destination address selection image or the reply mail text message description image; however, it is preferable that the reply mail information code and the reply destination address selection image be formed on one recording medium.

[Sequence from Scanning Mail Receiver Sheet to Receiving Mail]

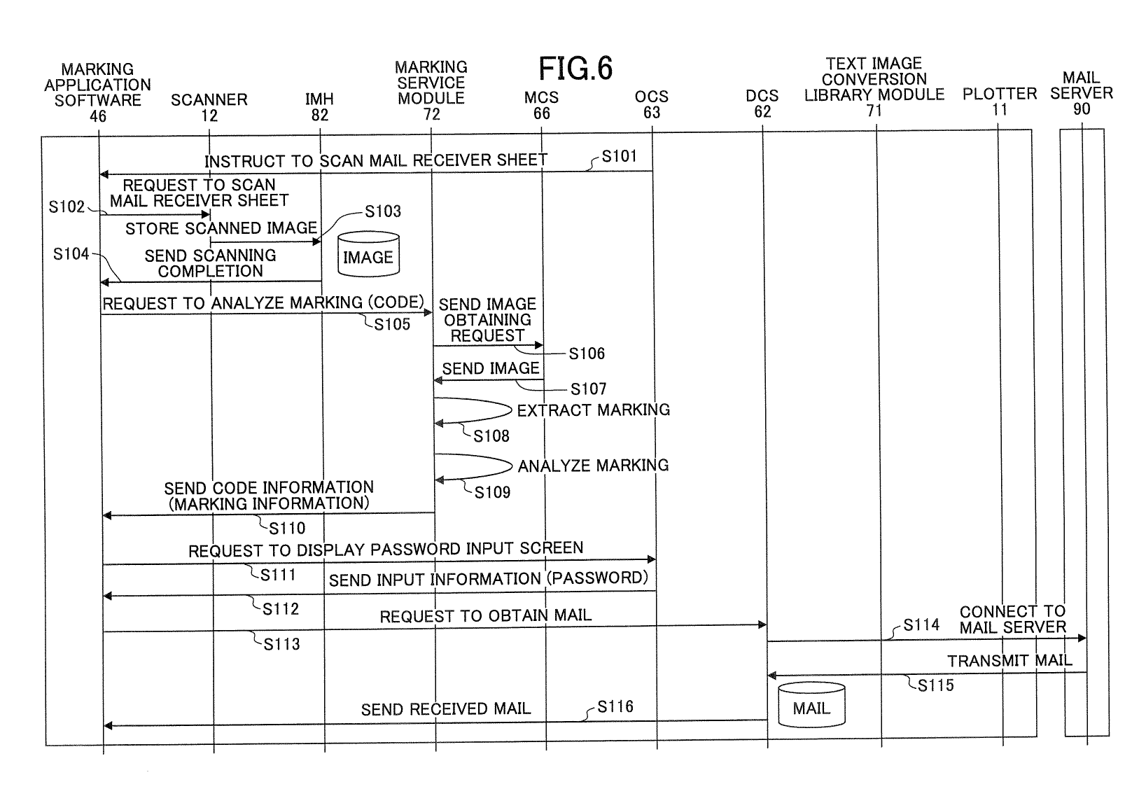

FIG. 6 is a sequence chart showing processes from scanning a mail receiver sheet to receiving a mail. In FIG. 6, processes from reading a mail receiver sheet including mail information code of mails to be received by the scanner 12 to receiving a mail are shown.

First, the OCS 63 instructs the marking application software 46 to scan a mail receiver sheet (S101). The instruction to the OCS 63 is executed by a user input on the operating panel 120.

The marking application software 46 requests the scanner 12 to scan the mail receiver sheet (S102). The scanner 12 reads an image of the mail receiver sheet and informs the IMH 82 of completion of storing the image (S103). The IMH 82 informs the marking application software 46 of completion of scanning the image (S104).

The marking application software 46 sends a request for analyzing a received mail information code (marking) to the marking service module 72 (S105). The marking application software 46 sends the request with position information of the received mail information code on the mail receiver sheet. The position information is the coordinates or a Field ID which is a field identification number in the mail receiver sheet. The position information can be obtained from a recording medium in which the position information has been stored beforehand of the MFP 1, or can be obtained by analyzing the received mail information code by using a predetermined method.

The marking service module 72 sends an image obtaining request with the position information of the received mail information code to the MCS 66 (S106). The MCS 66 sends an image obtained based on the position information to the marking service module 72 (S107).

The marking service module 72 extracts the received mail information code (marking) from the sent image (S108). The marking service module 72 obtains received mail information (marking information) such as a mail account and a mail server address by analyzing the extracted received mail information code (S109). In addition, the marking service module 72 sends the received mail code information to the marking application software 46 (S110).

The marking application software 46 requests the OCS 63 to display a screen on which the identification information such as a password is requested to be input (S111).

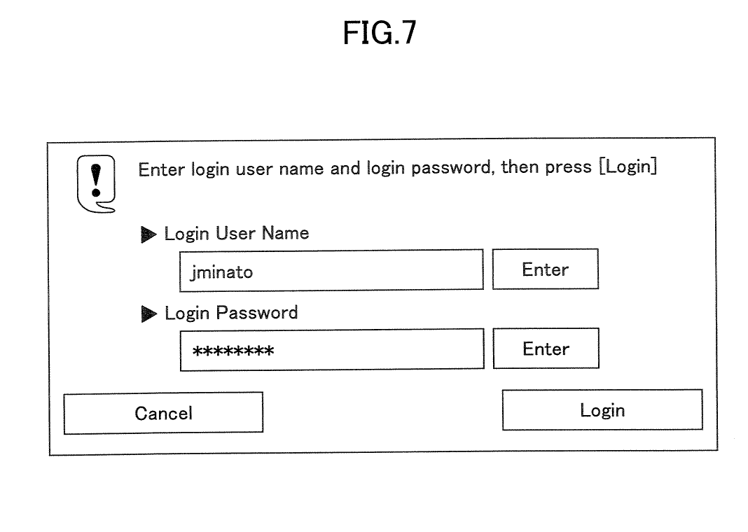

FIG. 7 is a diagram showing a screen on which the identification information such as a password is requested to be input. In FIG. 7, a field to which a user name is input and a field to which a password is input are shown, in addition, enter keys which are pushed after inputting the user name and the password are shown.

The OCS 63 sends the input identification information to the marking application software 46 (S112). The marking application software 46 determines whether the input identification information is the same as that stored in the MFP 1.

The processes in steps S111 and S112 are not absolutely needed in an information processing method according to the present embodiment. That is, the identification information can be included in the mail information code of mails. When the identification information input in step S112 is the identification information for the mail account or the mail server address, a mail server 90 can determine whether the mail account or the mail server address is the same as that in the mail server 90.

The marking application software 46 sends a mail obtaining request with the mail information of the mails to be received to the DCS 62 (S113). The DCS 62 connects with the mail server 90 disposed outside the MFP 1 (S114). The mail server 90 transmits a received mail or a group of received mails to the DCS 62 (S115).

The DCS 62 sends, for example, a received mail title list to the marking application software 46 (S116).

[Sequence for Selecting Reply Mail from Received Mail(s)]

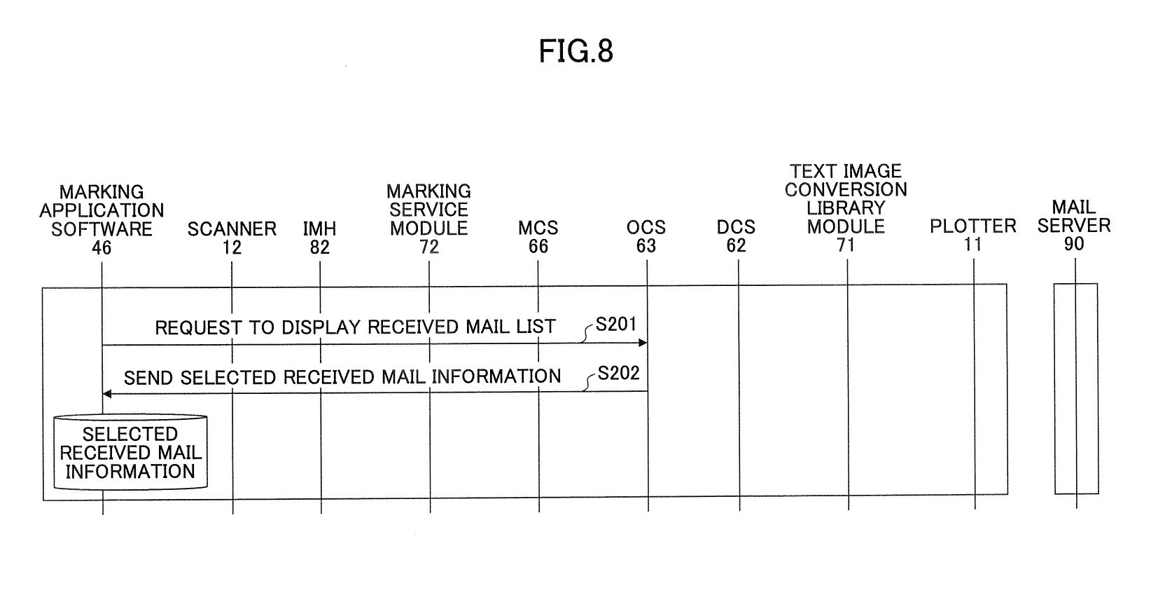

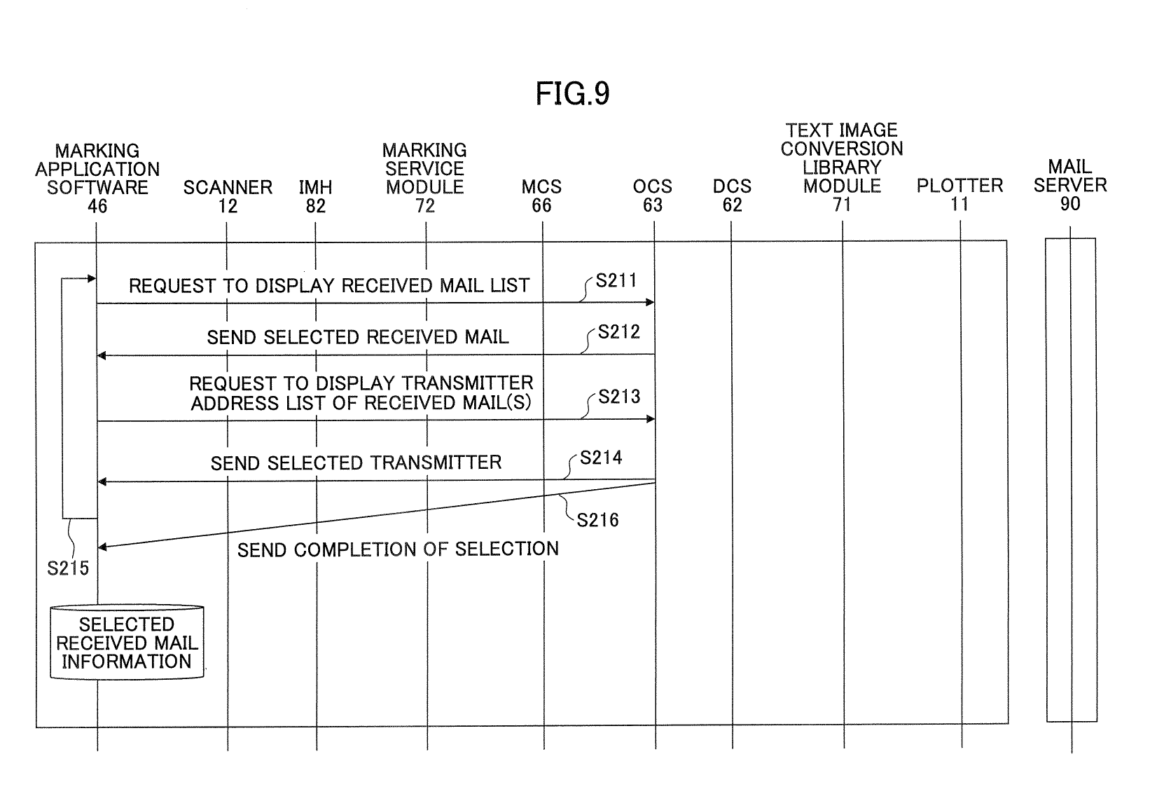

FIG. 8 is a sequence chart showing processes for selecting a reply mail from one or more received mails. FIG. 9 is another sequence chart showing processes for selecting a reply mail from one or more received mails. In FIG. 8, one or more received mails are selected. In FIG. 9, one or more received mails are selected and one or more reply destination addresses are selected corresponding to the selected one or more received mails.

First, the processes shown in FIG. 8 are described. First, the marking application software 46 requests the OCS 63 to display the received mail list (S201). The OCS 63 sends selected received mail information which is input on the operating panel 120 to the marking application software 46 (S202). In the process in step S202, one or more received mails are selected.

Next, the processes shown in FIG. 9 are described. First, the marking application software 46 requests the OCS 63 to display the received mail list (S211). The OCS 63 sends a selected received mail which is input on the operating panel 120 to the marking application software 46 (S212).

The marking application software 46 requests the OCS 63 to display a transmitter address list of the selected one or more received mails (S213). When the transmitter address list is displayed on the operating panel 120, the OCS 63 sends a selected transmitter address to the marking application software 46 (S214). When the selection of the transmitter address is completed, the OCS 63 informs the marking application software 46 of the completion of the reply destination address selection (S216).

Next, the processes from step S211 through step 214 are repeated (S215).

In steps S213 and S214, a reply destination address is selected from a transmitter address of the received mail. However, in the information processing method according to the present embodiment, a thumbnail image of the received mail is displayed and the reply destination address can be selected by using the thumbnail image. In addition, a part which is referred to in the reply mail can be obtained from the received mail. Further, when the received mail is transferred to an address, the address can be obtained from an address book managed by the MFP 1. In addition, in steps from S211 through S214, when plural received mails are selected, a destination address list is displayed and the reply destination address(S) can be selected from the destination address list. Moreover, when a part of the text message of the received mail is referred to the text message of a reply mail, the part can be selected.

[Displaying Received Mail List on Operating Panel 120]

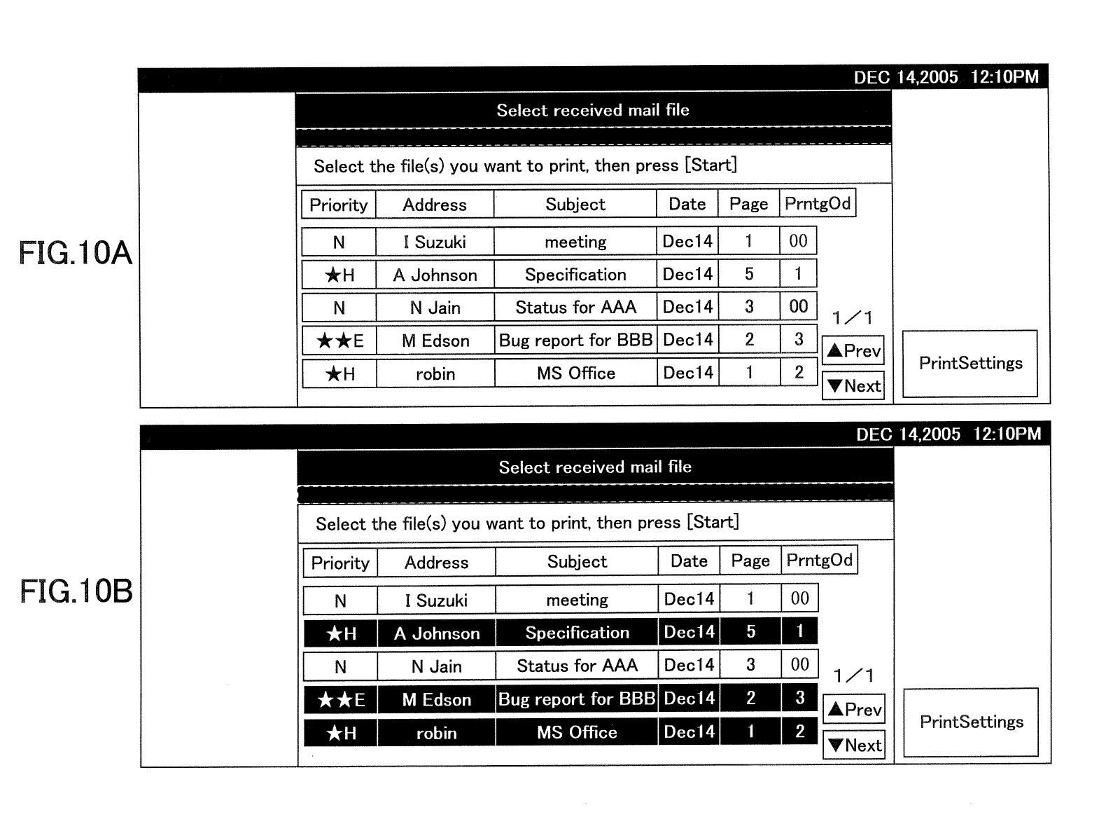

FIG. 10A is a diagram showing a received mail list on the operating panel 120. FIG. 10B is another diagram showing a received mail list on the operating panel 120.

In FIGS. 10A and 10B, in the received mail list, the transmitter address (Address), the title of the received mail (Subject), the transmitted date (Date), the number of pages of the received mail (Page), the printing order (PrntgOd), and priority of the received mail (Priority) are displayed on the operating panel 120.

In FIGS. 10A and 10B, in a case where the number of the received mails is greater than the screen region, when the list is scrolled by using a button “Prev” or “Next”, the received mail list can be displayed.

In FIG. 10B, three received mails are selected based on the priority thereof. That is, the selected three received mails are displayed with a black background.

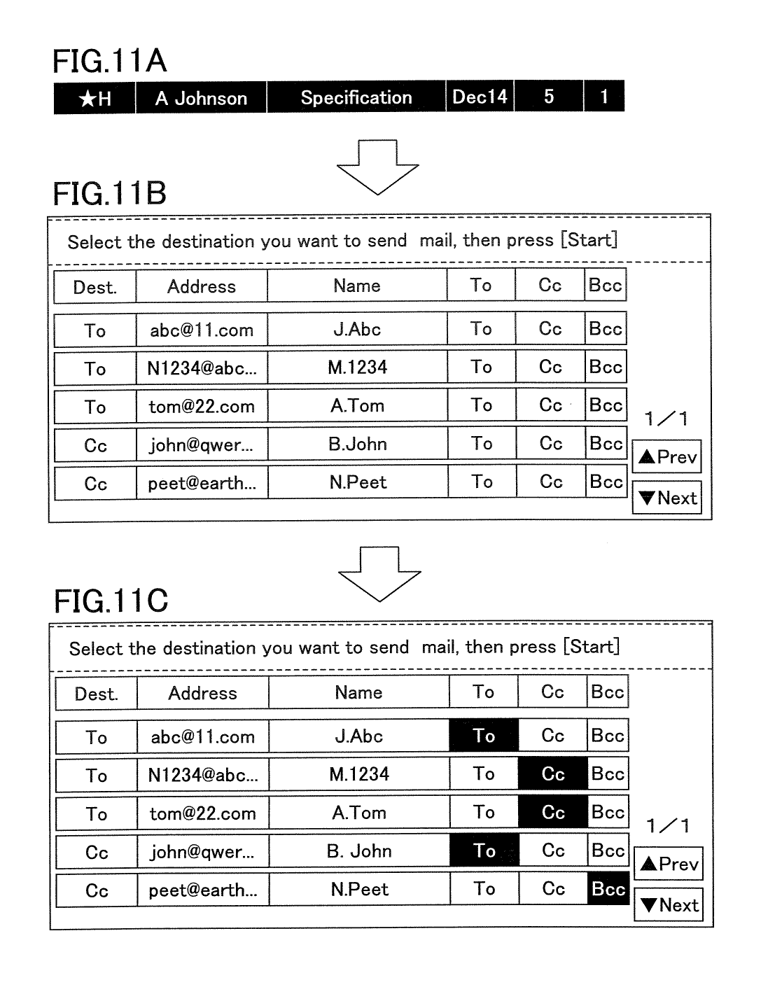

FIG. 11A is a diagram showing one of the selected received mails shown in FIG. 10B. FIG. 11B is a diagram showing destination addresses (names) of the selected received mail shown in FIG. 11A. In FIG. 11B, the destination attributes of “To”, “Cc”, and “Bcc”, the destination address (Address), and the person name of the address (Name) are displayed. When a reply mail is transmitted, the destination attributes of “To”, “Cc”, and “Bcc” are needed; therefore, buttons for selecting one of the attributes “To”, “Cc”, or “Bcc” are displayed.

FIG. 11C is a diagram showing destination addresses of a reply mail for the selected received mail shown in FIG. 11A. That is, the destination attribute “To”, “Cc”, or “Bcc” is selected for each reply mail address destination. In FIG. 11C, the selected attribute is shown with a black background.

[Output of Reply Mail Text Message Description Image]

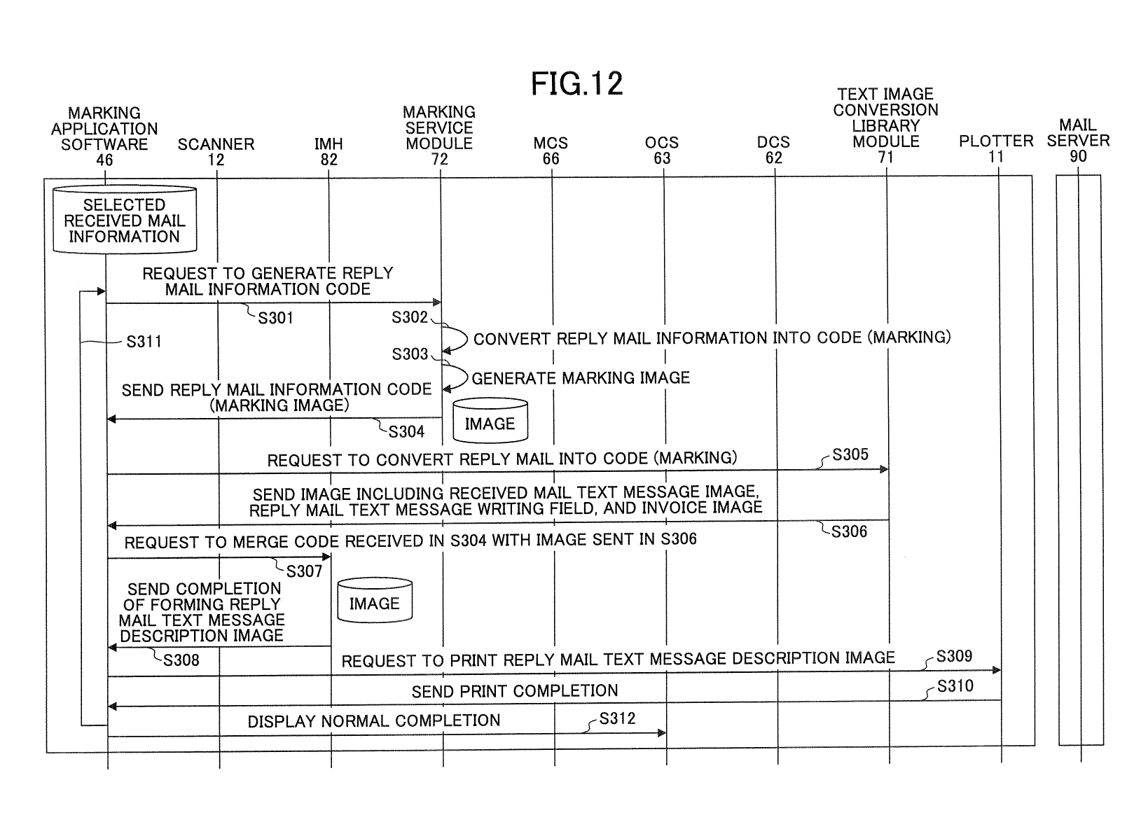

FIG. 12 is a sequence chart showing processes for outputting a reply mail text message description image based on reply mail information.

First, the marking application software 46 sends a reply mail information code generating request (marking image generating request) with reply mail information to the marking service module 72 (S301). The reply mail information includes a reply destination address, a transmitter address of the reply mail, and a mail server address. The transmitter address can be obtained from, for example, the mail account in the received mail information, a mail address input on the operating panel 120, or a mail address stored in a recording medium of the MFP 1.

The marking service module 72 converts the reply mail information into a code (S302). The marking service module 72 generates a reply mail information code image (marking image) (S303).

The marking service module 72 sends the reply mail information code image to the marking application software 46 (S304). The marking application software 46 requests the text image conversion library module 71 to convert a referring part of the received mail and an invoice into codes by sending the referring part of the received mail, the invoice data, and layout information of the received mail (S305). The text image conversion library module 71 sends a received mail text message image, a reply mail text message describing field, an image including an invoice image (S306).

The marking application software 46 requests the IMH 82 to merge the images received in step S306 with the reply mail information code received in step S304 (S307). With this, a reply mail text message description image is formed. The IMH 82 informs the marking application software 46 of the completion of forming the reply mail text message description image (S308).

The marking application software 46 requests the plotter 11 to print the reply mail text message description image (S309). The plotter 11 sends a printing completion response to the marking application software 46 after printing the reply mail text message description image (S310).

Next, the processes from step S301 through S310 are repeated for the number of the selected received mails to which reply mails are to be transmitted (S311). When one reply mail is transmitted to plural received mails, the processes from step S301 through S310 are repeated for the number of the plural received mails. In this case, in step S305, the referring parts are obtained from the plural received mails. In addition, the selection of the referring part and the order of the referring parts can be executed.

When the plotter 11 sends the printing completion response to the marking application software 46, the marking application software 46 requests the OCS 63 to display normal completion. The operating panel 120 displays the normal completion and the processes end (S312).

[Reply Mail Text Message Description Image]

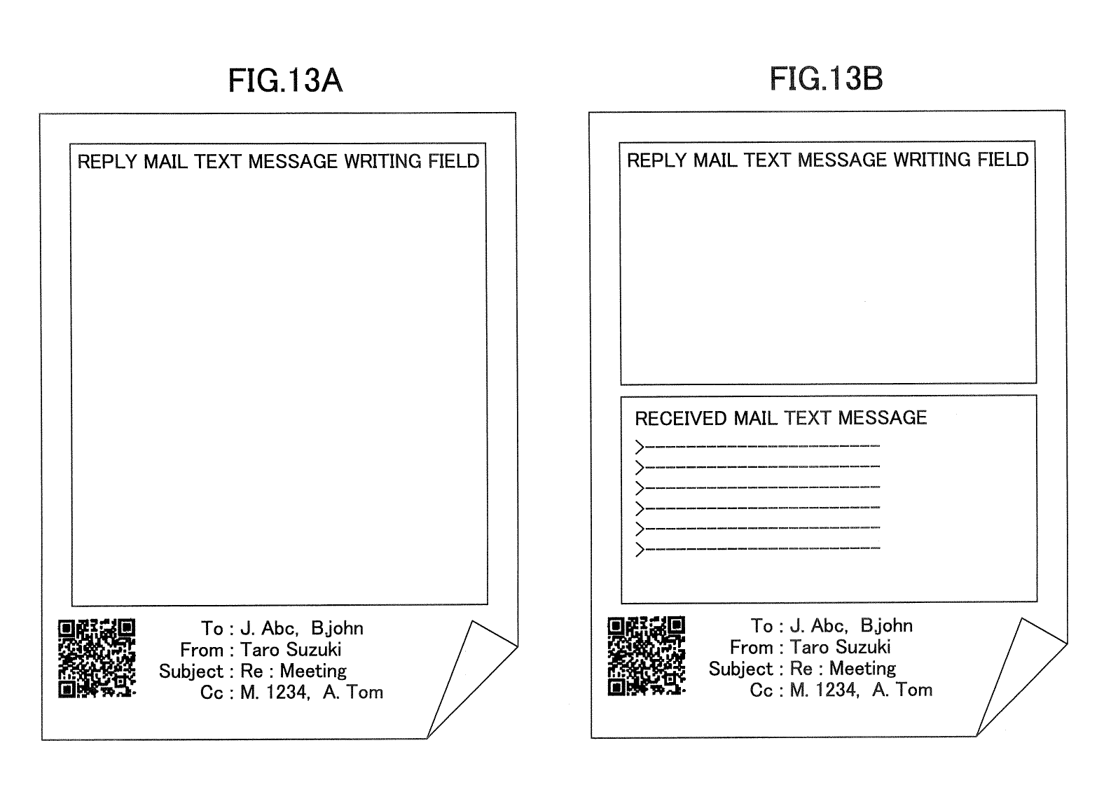

FIG. 13A is a diagram showing a reply mail text message description image. In FIG. 13A, a reply mail text message writing field, a reply mail information code (QR code), and an invoice image are shown. Since the invoice image is shown, a received mail for which a reply mail is to be transmitted can be easily obtained.

FIG. 13B is a diagram showing a reply mail text message description image in which a text message of a received mail is referred to. In FIG. 13B, a selected referring part of the text message of the received mail has a predetermined sign, for example, “>” at the head of each of the lines of the sentence.

[Processes for Forming Reply Destination Address Selection Image]

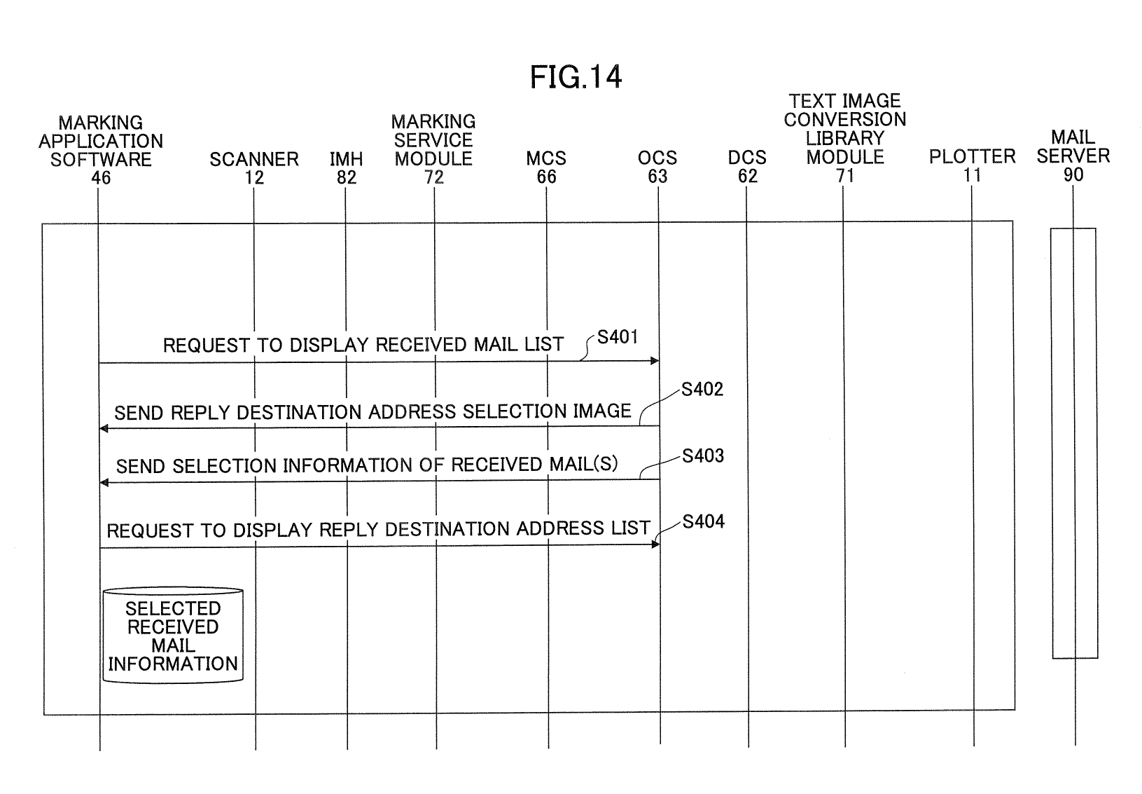

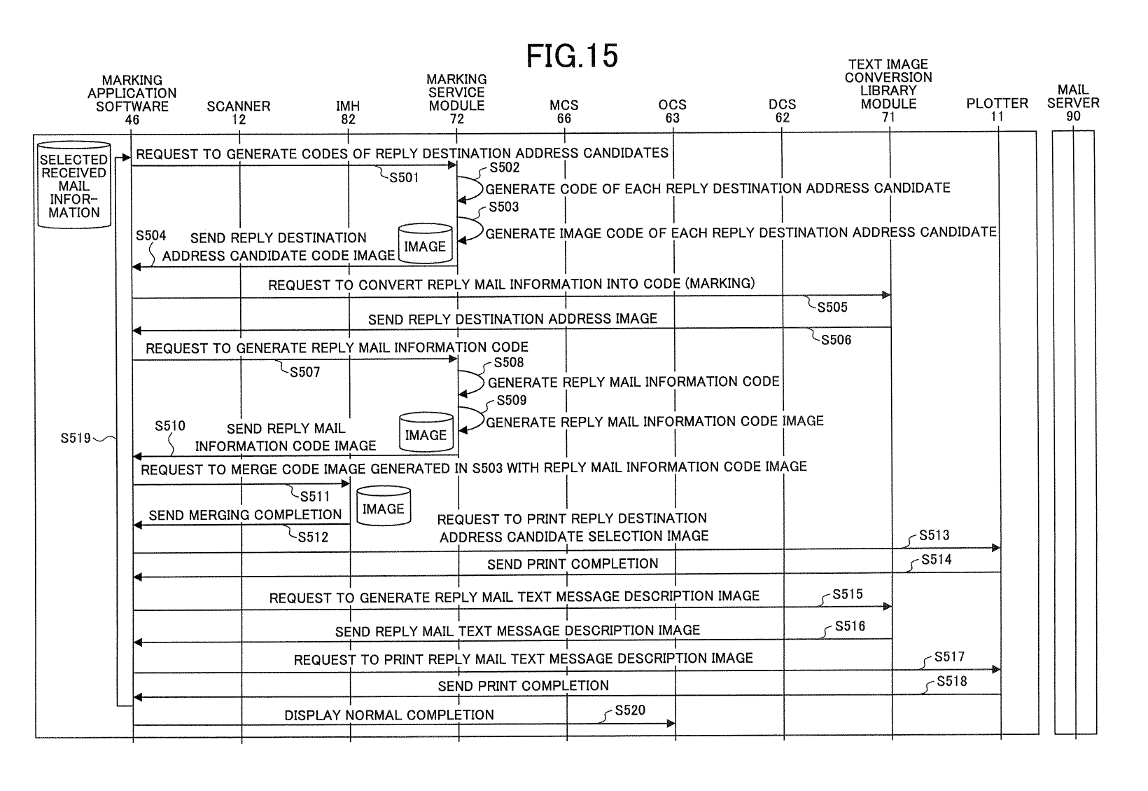

A reply destination address selection image is formed by processes shown in FIG. 14 through FIG. 15.

FIG. 14 is a sequence chart showing processes for obtaining a reply destination address candidate.

In FIG. 14, the marking application software 46 requests the OCS 63 to display a received mail list (S401). The OCS 63 forms a reply destination address selection image and sends the formed image to the marking application software 46 (S402). In addition, the OCS 63 sends selection information of the received mail for which the reply destination address selection image is formed (S403). That is, the OCS 63 selects one or more received mails.

The marking application software 46 requests the OCS 63 to display a reply destination address list (S404). That is, a reply destination address candidate is displayed.

FIG. 15 is a sequence chart showing processes for forming a reply destination address selection image.

First, the marking application software 64 requests the marking service module 72 to form image codes for reply destination address candidates so that all destination addresses of the selected received mails are the reply destination address candidates (S501). That is, the marking application software 64 requests the marking service module 72 to form all destination addresses of the selected received mails. The marking service module 72 forms a code (marking) for each reply destination address candidate (S502). The marking service module 72 forms a reply destination address candidate code (marking) based on the code formed in step S502 (S503). The marking service module 72 sends the reply destination address candidate code image to the marking application software 46 (S504).

The marking application software 46 sends the reply destination address candidates, the attributes “To”, “Cc”, and “Bcc”, and the layout information to the text image conversion library module 71, and requests to convert the candidates, the attributes, and the layout information into images (S505). The text image conversion library module 71 sends the images showing the reply destination addresses to the marking application software 46 (S506).

The marking application software 46 requests the marking service module 72 to form a reply mail information code and sends the transmitter addresses and the mail server address (S507). The marking service module 72 forms a reply mail information code (marking) (S508). The marking service module 72 converts the reply mail information code into an image and forms a reply mail information image (S509). The marking service module 72 sends the reply mail information code image to the marking application software 46 (S510).

The marking application software 46 requests the IMH 82 to merge an image having the reply destination address candidate code formed in step S507 with the reply mail information code and requests to form a reply destination address selection image (S511). The IMH 82 sends an image merging completion response to the marking application software 46 (S512).

The marking application software 46 requests the plotter 11 to print the reply destination address candidate selection image (S513). The plotter 11 sends a printing completion response to the marking application software 46 after printing the reply destination address candidate selection image (S514).

The marking application software 46 requests the text image conversion library module 71 to form a reply mail text message description image and sends a referring part and the layout information to the text image conversion library module 71 (S515). The text image conversion library module 71 sends the reply mail text message description image to the marking application software 46 (S516).

The marking application software 46 requests the plotter 11 to print the reply mail text message description image (S517). The plotter 11 sends a printing completion response to the marking application software 46 after printing the reply mail text message description image (S518).

Next, the processes from step S501 through S518 are repeated for the number of the selected received mails for which reply mails are to be transmitted (S519). When one reply mail is to be transmitted to plural received mails, the processes from step S501 through S518 are repeated for the number of the plural received mails. When the processes for all selected received mails or for all reply mails to be transmitted are completed, the marking application software 46 requests the OCS 63 to display the normal completion of the processes. When the operating panel 120 displays the normal completion, the processes end (S520).

[Reply Mail Text Message Description Image]

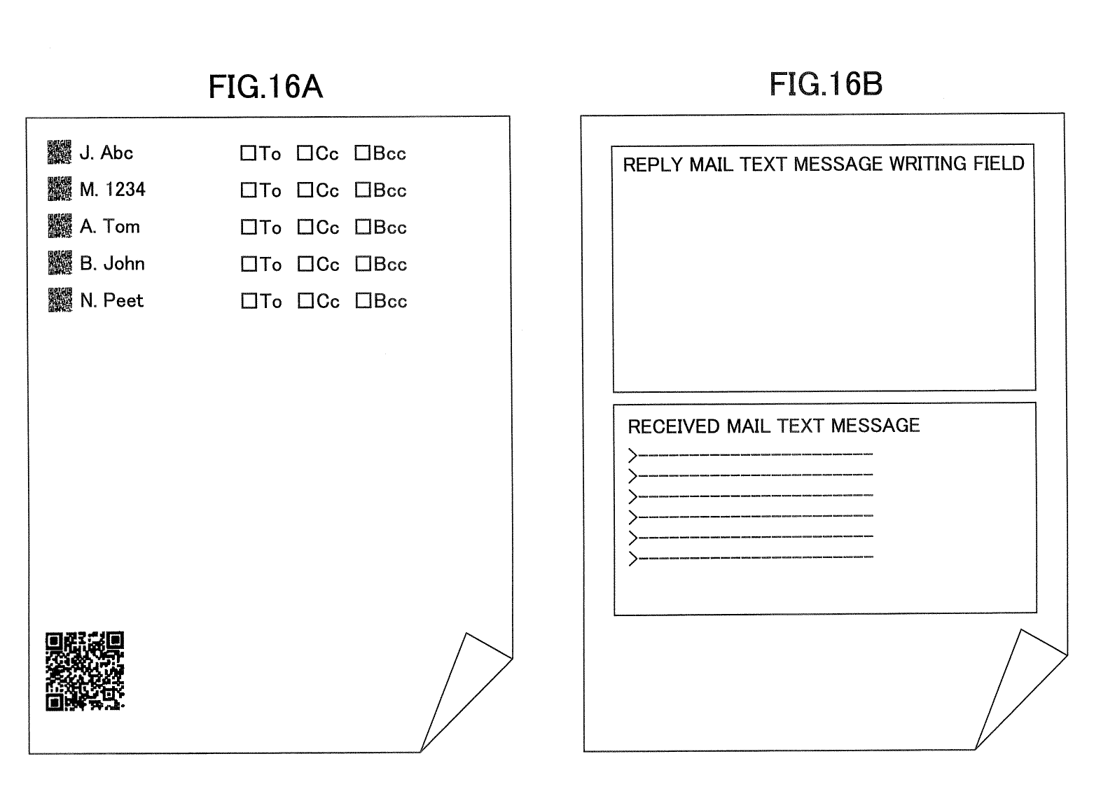

FIG. 16A is a diagram showing a reply destination address selection image. The reply destination address selection image shown in FIG. 16A includes a reply mail information code (QR code), person names of reply destination addresses which are candidates for a reply mail, attributes of “To”, “Cc”, and “Bcc”, and check boxes for selecting the attributes.

FIG. 16B is a diagram showing a reply mail text message description image corresponding to the reply destination address selection image shown in FIG. 16A. The reply mail text message description image shown in FIG. 16B includes a reply mail text message writing field and an image of a referred part of the text message of the received mail. The reply mail text message description image shown in FIG. 16B does not include a reply mail information code and an invoice image; however, the reply mail text message description image can include the reply mail information code and the invoice image. When the reply mail text message description image includes the invoice image, the invoice image includes a reply mail title and a reply mail transmitter address, but does not include a reply destination address.

[Processes for Obtaining Reply Mail Information from Reply Mail Information Code]

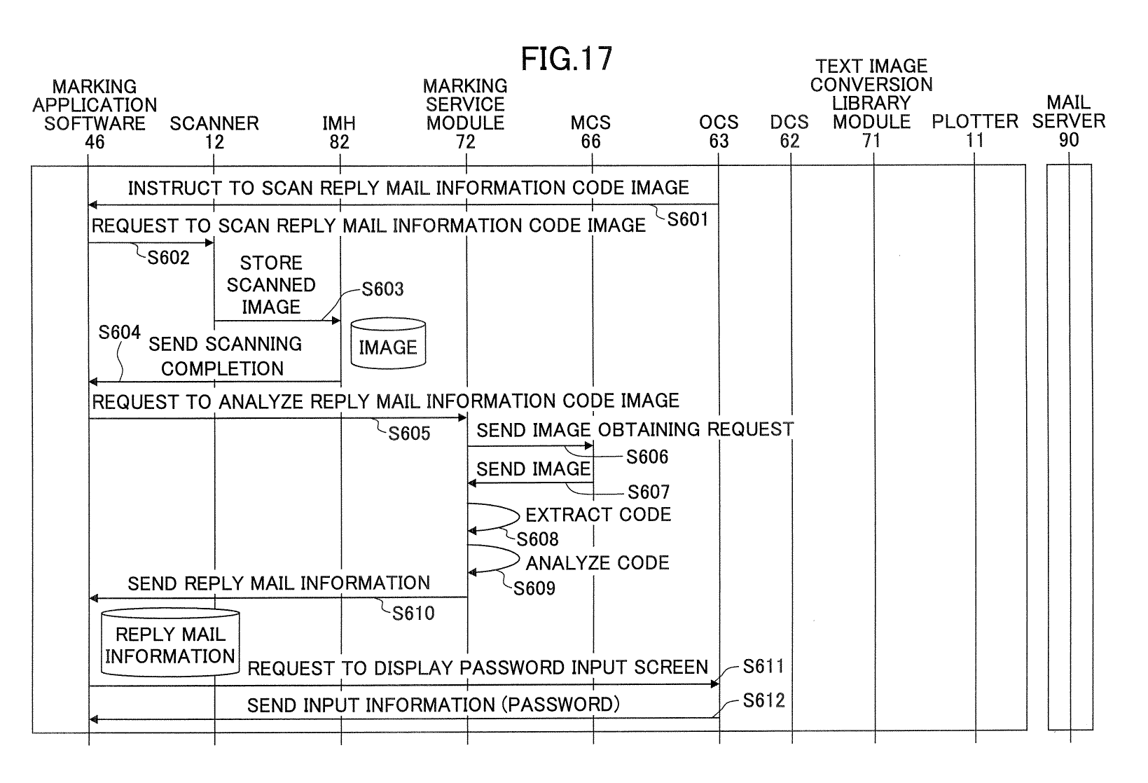

FIG. 17 is a sequence chart showing processes for obtaining reply mail information from a reply mail information code.

First, the OCS 63 instructs the marking application software 46 to scan the reply mail information code image (S601). The instruction to the OCS 63 is based on an input by a user on the operating panel 120.

The marking application software 46 requests the scanner 12 to scan the code image (S602). The scanner 12 reads the image and informs the IMH 82 of completion of storing the image (S603). The IMH 82 informs the marking application software 46 of completion of scanning the image (S604).

The marking application software 46 sends a request for analyzing the reply mail information code image to the marking service module 72 (S605). The marking application software 46 sends the request with position information of the reply mail information code on the recording medium. The position information is the coordinates or a Field ID which is a field identification number in the recording medium. The position information can be obtained from a recording medium in which the position information has been stored beforehand of the MFP 1, or can be obtained by analyzing the reply mail information code image by using a predetermined method.

The marking service module 72 sends an image obtaining request with the position information of the reply mail information code to the MCS 66 (S606). The MCS 66 sends an image obtained based on the position information to the marking service module 72 (S607).

The marking service module 72 extracts the reply mail information code (marking) from the sent image (S608). The marking service module 72 obtains reply mail information (marking information) such as a mail account and a mail server address by analyzing the reply mail information code (S609). In addition, the marking service module 72 sends the reply mail information to the marking application software 46 (S610).

The marking application software 46 requests the OCS 63 to display a screen on which the identification information such as a password is requested to be input (S611). As the screen on which the password is requested to be input, the screen shown in FIG. 7 can be used. The OCS 63 sends the input identification information to the marking application software 46 (S612). The marking application software 46 determines whether the input identification information is the same as that stored in the MFP 1.

The processes in steps S611 and S612 are not absolutely needed in the information processing method according to the present embodiment. That is, the identification information can be included in the reply mail information code. When the identification information input in step S611 is the identification information of the mail account or the mail server address, the mail server 90 can determine whether the mail account or the mail server address is the same as that in the mail server 90.

[Processes for Transmitting Reply Mail based on Reply Mail Information]

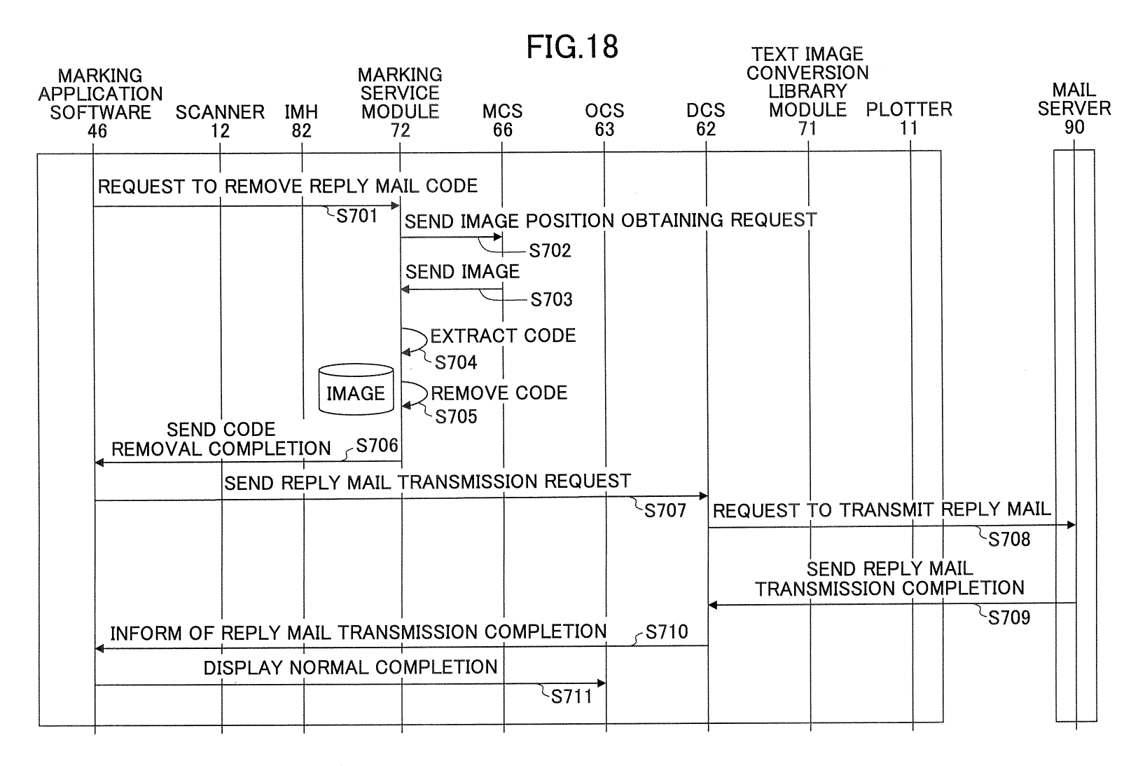

FIG. 18 is a sequence chart showing processes for transmitting a reply mail based on reply mail information. The processes shown in FIG. 18 are executed after the processes shown in FIG. 17. That is, the processes shown in FIG. 18 are executed after obtaining the reply mail information from the reply mail information code.

First, the marking application software 46 requests the marking service module 72 to remove the reply mail image code from the reply mail text message description image and sends the position information of the reply mail image code to the marking service module 72 (S701). The position information is the coordinates or a Field ID which is a field identification number in the recording medium. The position information can be obtained from a recording medium in which the position information has been stored beforehand of the MFP 1, or can be obtained by analyzing the reply mail code by using a predetermined method.

The marking service module 72 sends an image position obtaining request with the position information of the reply mail information code to the MCS 66 (S702). The MCS 66 sends an image obtained based on the position information to the marking service module 72 (S703).

The marking service module 72 extracts the reply mail information code from the sent image (S704). The marking service module 72 removes the reply mail information code by, for example, changing the color of the reply mail information code to white, which is a background color (S705). The marking service module 72 informs the marking application software 46 of the completion of the removal of the reply mail information code (S706).

The processes from step S701 through S706 are not absolutely needed in the information processing method according to the present embodiment.

The marking application software 46 sends a reply mail transmission request with the reply mail information to the DCS 62 (S707). The DCS 62 transmits the reply mail by connecting to the mail server 90 disposed outside the MFP 1 (S708). The mail server 90 informs the DCS 62 of the transmission completion of the reply mail after transmitting the reply mail (S709).

The DCS 62 informs the marking application software 46 of the transmission completion of the reply mail (S710). The marking application software 46 requests the OCS 63 to display the normal transmission completion of the reply mail (S711).

[Processes for Transmitting Reply Mail based on Reply Mail Address selection Image]

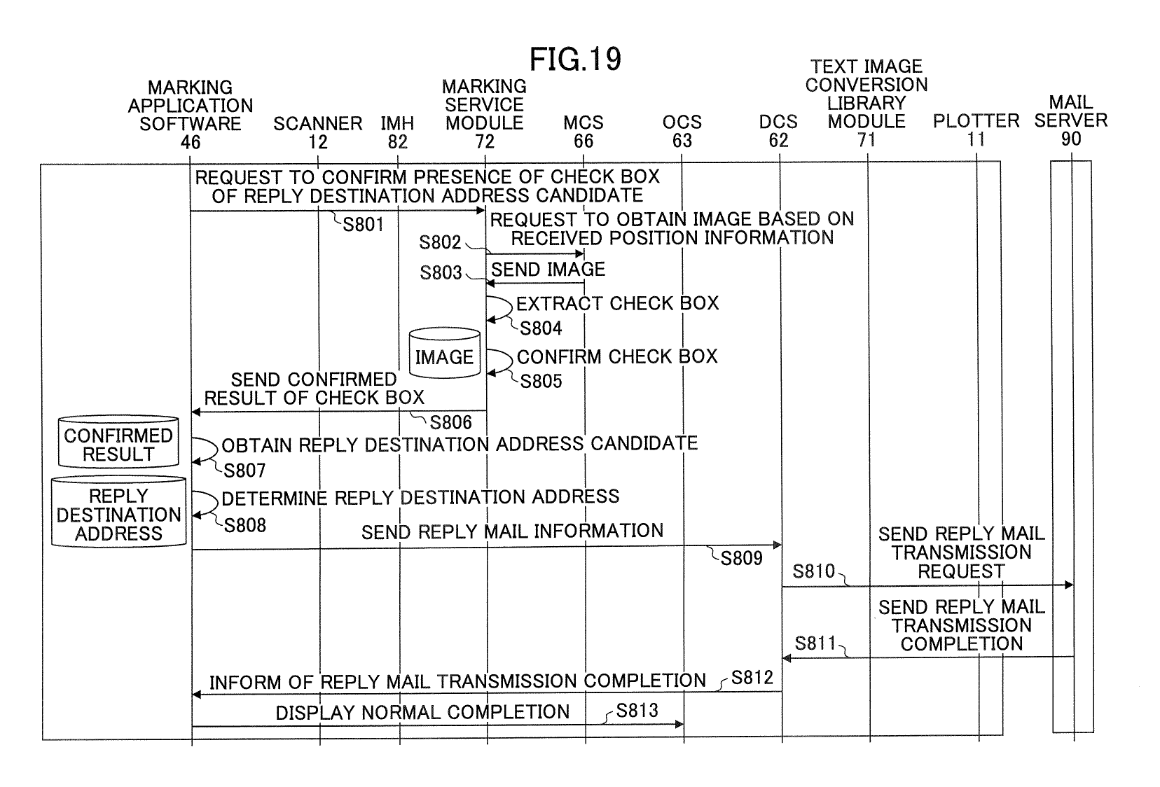

FIG. 19 is a sequence chart showing processes for transmitting a reply mail based on a reply mail address selection image. The processes shown in FIG. 19 are executed after the processes shown in FIG. 17. That is, the processes shown in FIG. 19 are executed after obtaining the reply mail information from the reply mail information code and after reading the reply destination address selection image stored in a recording medium by the scanner 12.

First, the marking application software 46 requests the marking service module 72 to confirm the presence of a check box corresponding to a reply destination address candidate and sends the position information of a field including the check box and the reply destination address code (S801). The position information is the coordinates or a Field ID which is a field identification number in the reply destination address selection image. The position information can be obtained from a recording medium in which the position information has been stored beforehand of the MFP 1, or can be obtained by analyzing the reply destination address selection image by using a predetermined method.

The marking service module 72 requests the MCS 66 to obtain an image based on the received position information (S802). The MCS 66 sends the image obtained based on the position information to the marking service module 72 (S803).

The marking service module 72 extracts the check box and the reply destination address code from the obtained image (S804). The marking service module 72 confirms the presence of a mark in the extracted check box and obtains a reply destination address candidate from the reply destination address candidate code (S805). The marking service module 72 sends information indicating the presence of the mark in the check box and the reply destination address candidate corresponding to the check box to the marking application software 46 (S806).

The marking application software 46 obtains the reply destination address candidate corresponding to the check box having the mark based on the presence of the mark (S807). Then the marking application software 46 determines that the obtained reply destination address candidate is the reply destination address (S808).

The marking application software 46 sends a reply mail transmission request with the reply mail information including the reply destination address and the reply mail text message to the DCS 62 (S809). The DCS 62 requests the mail server 90 to transmit the reply mail (S810). The mail server 90 informs the DCS 62 of the transmission completion of the reply mail after transmitting the reply mail (S811). The DCS 62 informs the marking application software 46 of the transmission completion of the reply mail (S812).

The marking application software 46 requests the OCS 63 to display the normal transmission completion of the reply mail (S813). Then the processes end.

[Reply Destination Address Selection Image]

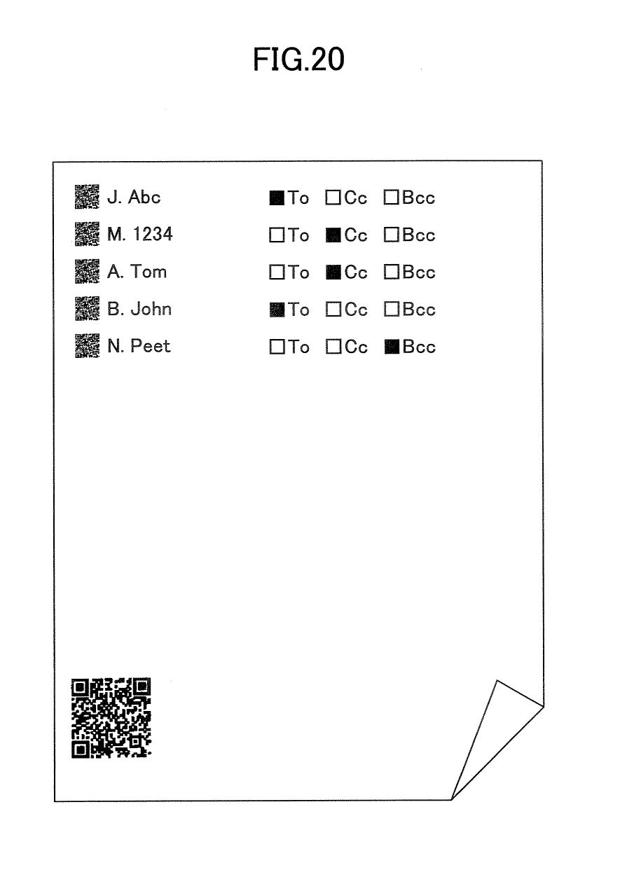

FIG. 20 is a diagram showing a reply destination address selection image in which the check boxes of the corresponding attributes are marked.

In FIG. 20, in each selected reply destination address (name), one of the attributes “To”, “Cc”, and “Bcc” is selected and marked. As shown in FIG. 20, the reply mail is transmitted to each reply destination address with the selected attribute. For example, the reply mail is transmitted to Mr. J. Abc and Ms. B. John with the attribute “To”, to Ms. M. 1234 and Mr. A. Tom with the attribute “Cc”, and to Mr. N. Peet with the attribute “Bcc”.

In the above processes in each sequence chart, the processes executed by the marking application software 46 are not limited to being executed by the marking application software 46. That is, the processes can be executed by the marking application software 46 and one or more other application software packages, or by one or more application software packages other than the marking application software 46.

Further, the present invention is not limited to the specifically disclosed embodiment, and variations and modifications may be made without departing from the scope of the present invention.

The present invention is based on Japanese Priority Patent Application No. 2006-031259, filed on Feb. 8, 2006, with the Japanese Patent Office, the entire contents of which are hereby incorporated herein by reference.

What is claimed is:

1. An information processing apparatus which forms an image including a reply mail text message writing field to which a reply mail text message is written for transmitting a reply mail in response to a received mail based on received mail information written as an image code, comprising:
a received mail information obtaining unit for obtaining the received mail information including a mail account and a mail server address from the image code;
a reply destination address obtaining unit for obtaining a reply destination address for the received mail from the received mail information;
a transmitter address obtaining unit for obtaining a transmitter address of the received mail which address is a mail address of the mail account;
a reply mail information code generating unit for generating a reply mail information code in which reply mail information including the reply destination address, the transmitter address, and the mail server address is converted into an image code;
an invoice image generating unit for generating an invoice image including the reply destination address or the transmitter address; and
a reply mail text message description image forming unit for forming a reply mail text message description image including the reply mail information code, the invoice image, and the reply mail text message writing field.

2. The information processing apparatus as claimed in claim 1, further comprising:
a received mail text message selecting unit for selecting a part of the text message of the received mail which part is referred to in the text message of the reply mail; and
a received mail text message image generating unit for generating a received mail text message image in which text data of the part to be referred to selected by the received mail text message selecting unit are converted into an image; wherein
the reply mail text message description image forming unit forms a reply mail text message description image including the received mail text message image formed by the received mail text message image generating unit.

3. The information processing apparatus as claimed in claim 1, further comprising:
a reply destination address selecting unit for selecting the reply destination address; wherein
when the number of destination addresses of the received mail is plural, the reply destination address obtaining unit obtains plural destination addresses as reply destination address candidates; and
the reply destination address selecting unit selects one or more reply destination addresses from the reply destination address candidates.

4. The information processing apparatus as claimed in claim 1, further comprising:
when the number of destination addresses of the received mail is plural,
a reply destination address candidate generating unit for generating plural destination addresses as reply destination address candidates;
a reply destination address candidate code generating unit for generating a reply destination address candidate code in which text data of the reply destination address candidates generated by the reply destination address candidate generating unit are converted into an image code; and
a reply destination address selection image forming unit for forming a reply destination address selection image, in which the reply destination address candidate code generated by the reply destination address candidate code generating unit, text data of the reply destination address candidates, and a reply mail transmitting field in which transmission of the reply mail is determined correspond to each reply destination address candidate.

5. The information processing apparatus as claimed in claim 1, further comprising:
an identification information inputting unit for inputting identification information for the mail account or the mail server address, or inputting identification information of a user.

6. The information processing apparatus as claimed in claim 1, further comprising:
a received mail selecting unit for selecting one or more received mails for which a reply mail is to be transmitted from the plural received mails based on urgency information including in the received mails.

7. The information processing apparatus as claimed in claim 6, further comprising:
when plural received mails are selected by the received mail selecting unit,
a reply mail title candidate generating unit for generating reply mail title candidates from plural titles of the received mails; and
a reply mail title selecting unit for selecting one title from the plural mail title candidates generated by the reply mail title candidate generating.

8. The information processing apparatus as claimed in claim 1, further comprising:
a reply mail text message extracting unit for extracting the text message or an image of the reply mail from the reply mail text message description image in which the text message is written;
a reply mail information extracting unit for extracting reply mail information including in the reply mail text message description image as the image code; and
a reply mail generating unit for generating the reply mail from the reply mail information.

9. The information processing apparatus as claimed in claim 47 further comprising:
a reply destination address extracting unit for extracting a reply destination address from the reply destination address selection image in which a selected reply destination address is written.

10. The information processing apparatus as claimed in claim 1, further comprising:
a received mail information inputting unit for inputting the received mail information;
a received mail information code generating unit for generating a received mail information code by converting the received mail information input by the received mail information inputting unit into an image code; and
a received mail information code outputting unit for forming the received mail information code on a recording medium.

11. An information processing method which forms an image including a reply mail text message writing field to which a reply mail text message is written for transmitting a reply mail in response to a received mail based on received mail information written as an image code, comprising the steps of:
obtaining the received mail information including a mail account and a mail server address from the image code;
obtaining a reply destination address for the received mail from the received mail information;
obtaining a transmitter address of the received mail which address is a mail address of the mail account;
generating a reply mail information code in which reply mail information including the reply destination address, the transmitter address, and the mail server address is converted into an image code;
generating an invoice image including the reply destination address or the transmitter address; and
forming a reply mail text message description image including the reply mail information code, the invoice image, and the reply mail text message writing field.

12. The information processing method as claimed in claim 11, further comprising the steps of:
selecting a part of the text message of the received mail which part is referred to in the text message of the reply mail;
generating a received mail text message image in which text data of the selected part to be referred to are converted into an image; and
forming a reply mail text message description image including the received mail text message image.

13. The information processing method as claimed in claim 11, further comprising the step of:
when the number of destination addresses of the received mail is plural,
obtaining plural destination addresses as reply destination address candidates; and
selecting one or more reply destination addresses from the reply destination address candidates.

14. The information processing method as claimed in claim 11, further comprising the steps of:
when the number of destination addresses of the received mail is plural,
generating plural destination addresses as reply destination address candidates;
generating a reply destination address candidate code in which text data of the reply destination address candidates are converted into an image code; and
forming a reply destination address selection image, in which the reply destination address candidate code, text data of the reply destination address candidates, and a reply mail transmitting field in which transmission of the reply mail is determined correspond to each reply destination address candidate.

15. The information processing method as claimed in claim 11, further comprising the step of:
inputting identification information for the mail account or the mail server address, or inputting identification information of a user.

16. The information processing method as claimed in claim 11, further comprising the step of:
selecting one or more received mails for which a reply mail is to be transmitted from the plural received mails based on urgency information including in the received mails.

17. The information processing method as claimed in claim 16, further comprising the steps of:
when plural received mails are selected,
generating reply mail title candidates from plural titles of the received mails; and
selecting one title from the plural mail title candidates.

18. The information processing method as claimed in claim 11, further comprising the step of:
extracting the text message or an image of the reply mail from the reply mail text message description image in which the text message is written;
extracting reply mail information including in the reply mail text message description image as the image code; and
generating the reply mail from the reply mail information.

19. The information processing method as claimed in claim 14, further comprising the step of:
extracting a reply destination address from the reply destination address selection image in which a selected reply destination address is written.

20. The information processing method as claimed in claim 11, further comprising the steps of:
inputting the received mail information;
generating a received mail information code by converting the received mail information into an image code; and
forming the received mail information code on a recording medium.
